(19) United States
(12) Patent Application Publication
(10) Pub. No.: US 2025/0175080 A1
(43) Pub. Date: May 29, 2025

(54) MEASUREMENT OF INDUCTOR-CURRENT IN A POWER STAGE OF A SWITCHING CONVERTER

(71) Applicant: Shaoxing Yuanfang Semiconductor Co., Ltd., Shaoxing (CN)

(72) Inventors: Arnold J D'Souza, Bangalore (IN); Shyam Somayajula, Bangalore (IN)

(21) Appl. No.: 18/910,023

(22) Filed: Oct. 9, 2024

(30) Foreign Application Priority Data
Nov. 29, 2023 (IN) 202341080928

(51) Int. Cl. H02M 3/158; H02M 1/088

(52) U.S. Cl. CPC H02M 3/158; H02M 1/088

(57) ABSTRACT

A power stage of a switching converter contains a high-side switch and a low-side switch respectively operated by corresponding drive signals. A current-sense block generates a sensed-current signal which is blanked for a first duration upon start of a longer phase of a high-side phase and a low-side phase. The sensed-current signal is un-blanked upon end of the first duration. The current-sense block generates a first pulse starting synchronous with the start of the longer phase and with pulse-width equaling the first duration. A gate driver receives the first pulse and generates a delayed pulse starting synchronous with the start of the longer phase and with pulse-width equaling a sum of the first duration and a second duration. The gate driver generates drive signal (for the switch being driven with the longer phase) with a first logic level for a duration of at least the pulse-width of the delayed pulse.

### PRIORITY CLAIM

The instant patent application is related to and claims priority from the co-pending provisional India patent application entitled, “CURRENT-SENSE TBLANK IN FEEDBACK”, Serial No.: 202341080928, Filed: 29^{th} Nov. 2023; Attorney docket no.: AURA-352-INPR, which is incorporated in its entirety herewith to the extent not inconsistent with the description herein.

### BACKGROUND

### Technical Field

Embodiments of the present disclosure relate generally to switching converters, and more specifically to measurement of inductor-current in a power stage of a switching converter.

### Related Art

A switching converter refers to a component which generates a regulated DC (direct current) voltage from an input power source by employing one or more switches, as is well known in the relevant arts. Typically, a switching converter transforms the voltage (input supply voltage) of the input power source into a pulsed voltage by operating switch(es), the pulsed voltage then being smoothed using capacitors, inductors, and other elements to generate the regulated DC voltage. Power is supplied from the input to the output by turning ON and OFF switches (e.g., Metal Oxide Semiconductor Field Effect Transistor, MOSFETs) to generate and regulate the desired voltage. Switching converters are used in components such as regulated power supplies, which in turn are used in devices such as computers and mobile phones, as is also well known in the relevant arts.

A switching converter often contains a pair of switches driving an inductor. Each switch is typically implemented as a transistor (e.g., MOSFET) and the switches are connected in series between input supply voltage and a reference terminal (e.g., ground). The switch coupled closer to the input voltage (source of input power to the converter) is termed as the high-side switch, while the other one is termed as a low-side switch. The switches are operated by a control circuit which switches ON the transistors in successive non-overlapping time durations to cause the switch that is currently ON to drive the inductor in the corresponding duration.

A multi-phase switching converter contains multiple ones of such pairs of switches, along with associated circuitry for each pair. Each pair is typically operated in a corresponding phase of a sequence of phases, with the pairs together operating to generate the desired regulated voltage, and capable of supporting higher load currents at greater efficiencies as well as providing other advantages, as is well known in the relevant arts. Each of such pairs, along with the associated circuitry, is referred to as a power stage of the multi-phase switching converter. A phase controller operates to control the specific times that each of the power stages is operative in generating the desired output voltage.

Phase controllers often need to be communicated the magnitude of current supplied to the output by each power stage via a corresponding inductor, termed inductor-current information. Therefore, each power stage obtains (senses) the current through the inductor corresponding to that power stage, and provides the inductor-current information to the phase controller.

Several aspects of the present disclosure are directed to measurement of inductor-current in a power stage of a switching converter.

### BRIEF DESCRIPTION OF THE VIEWS OF DRAWINGS

Example embodiments of the present disclosure will be described with reference to the accompanying drawings briefly described below.

FIG. 1 is a block diagram of an example system in which several aspects of the present disclosure can be implemented.

FIG. 2 is a block diagram illustrating the details of a voltage regulator module (VRM) in an embodiment of the present disclosure.

FIG. 3 is a block diagram depicting implementation of blanking duration and minimum OFF-time in a prior power stage.

FIG. 4 is a diagram illustrating the implementation of a smart power stage (SPS) in an embodiment of the present disclosure.

FIG. 5 is a timing diagram (not to scale) illustrating the manner in which T-min-long is timed relative to T-blank, in an embodiment of the present disclosure.

FIG. 6 is a diagram illustrating pertinent implementation details of a current-sense block and a gate driver, in an embodiment of the present disclosure.

FIG. 7 is a diagram illustrating the implementation details of a delay block in an embodiment of the present disclosure.

FIG. 8A is a timing diagram (not to scale) illustrating example waveforms generated at various nodes of SPS in an embodiment of the present disclosure.

FIG. 8B is a timing diagram (not to scale) illustrating the manner in which a low-side switch is kept ON for the minimum OFF-time, in an embodiment of the present disclosure.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Overview

Aspects of the present disclosure are directed to a power stage of a switching converter. The power stage contains a high-side switch and a low-side switch respectively operated by a first drive signal and a second drive signal, with the first drive signal and the second drive signal to be respectively ON to drive respective currents through an inductor in a high-side phase and a low-side phase. A gate driver generates the first drive signal and the second drive signal based on a control signal received from a phase controller, wherein the control signal is received with a first logic level in a first interval and with a second logic level in a second interval.

A current-sense block generates a sensed-current signal representing an instantaneous magnitude of inductor-current flowing through the inductor, wherein the sensed-current signal is blanked for a first duration upon start of a longer phase of the high-side phase and the low-side phase, with the other one of the high-side phase and the low-side phase being a shorter phase. The sensed-current signal is un-blanked upon end of the first duration.

According to an aspect the current-sense block generates a first pulse starting synchronous with the start of the longer phase and with pulse-width equaling the first duration, wherein the gate driver receives the first pulse and generates a delayed pulse starting synchronous with the start of the longer phase and with pulse-width equaling a sum of the first duration and a second duration. In addition, the gate driver generates drive signal for the switch being driven with the longer phase, the drive signal being with the first logic level for a duration of at least said pulse-width of said delayed pulse.

In an embodiment, the low-side is the longer phase, wherein the sum represents a desired minimum duration for which the low-side switch is to be ON in the low-side phase.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example System

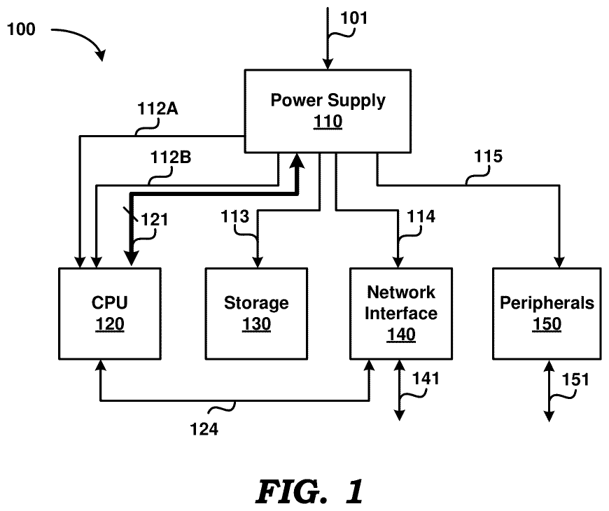

FIG. 1 is a block diagram of an example system in which several aspects of the present disclosure can be implemented. System 100 is shown containing power supply 110, central processing unit (CPU) 120, storage 130, network interface 140 and peripherals 150. In an embodiment, system 100 corresponds to a computer (desktop, laptop, etc.), although system 100 can represent other types of systems in other embodiments. It is understood that system 100 can contain more or fewer blocks than those shown in FIG. 1.

CPU 120, in general, represents a processor or a system-on-chip (SoC), and is shown as receiving a pair of supply voltages (Va and Vb) on respective paths 112A and 112B from power supply 110. As an example, Va may be a smaller voltage than Vb, and may be used to power a core portion of CPU which may include arithmetic logic unit (ALU), microprogram sequencer, registers, etc. Vb may be used to power the rest of CPU 120, such as for example, input/output (I/O) units, I/O buffers, on-chip peripherals etc. CPU 120 provides various signals (all deemed to be contained in path 121) specifying, among others, its power supply requirements to power supply 110. Examples of such signals can be those that specify the specific mode of operation (in terms of power consumption) such as PS1, PS2, PS3, etc., which refer to “Power Save States for Improved Efficiency”.

Storage 130 represents a memory that may include both volatile and non-volatile memories. For example, in a personal computer, storage can include magnetic memory (hard disk) as well as solid state memory (RAM, Flash, etc.). Storage 130 is shown receiving a supply voltage on path 113 for powering various circuits and blocks within.

Network interface 140 operates to provide two-way communication between system 100 and a computer network, or in general the Internet. Network interface 140 implements the electronic circuitry required to communicate using a specific physical layer and data link layer standard such as Ethernet or Wi-Fi™. Network interface 140 may also contain a network protocol stack to allow communication with other computers on a same local area network (LAN) and large-scale network communications through routable protocols, such as Internet Protocol (IP). Network interface 140 receives a power supply on path 114 for powering internal circuits and blocks. Network interface 140 receives from/transmits to external systems and CPU 120 respectively on path 141 and path 124.

Peripherals 150 represents one or more peripheral circuits, such as, for example, speakers, microphones, user interface devices, etc. Peripherals 150 receives a power supply on path 115, and communicates with external devices on path 151.

Power supply 110 receives power from one or more sources (e.g., battery) on path 101, and operates to provide the desired power supply voltages on paths 112A, 112B, 113, 114 and 115. In an embodiment, power supply 110 is designed to contain one or more multi-phase DC-DC converters within to generate the power supply voltages. Power supply 110 responds to signals from CPU 120 received on path 121 to control the multi-phase converters to reduce/increase current output based on the specific signal (e.g., PS1, PS2 and PS3).

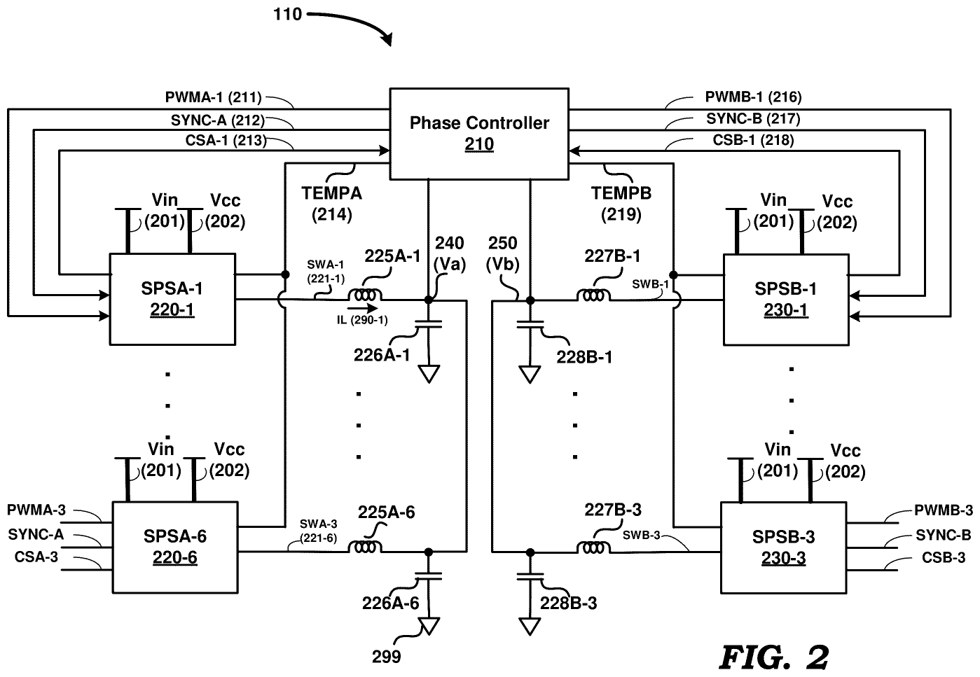

In the embodiment, power supply 110 is a voltage regulator module (VRM), sometimes also called processor power module (PPM), and contains one or more step-down switching (buck) converters to generate several smaller voltages from a higher-voltage supply source. In other embodiments however, other types of DC-DC converters such as boost, buck-boost, hysteretic converters etc., can be implemented instead of a buck converter. With a VRM, multiple devices/ICs requiring different supply voltages can be mounted on the same platform, for example, a computer motherboard of a personal computer (PC). Accordingly, the description is continued with respect to a VRM as shown in FIG. 2.

### 3. Voltage Regulator Module (VRM)

FIG. 2 is a block diagram illustrating the details of a VRM in an embodiment of the present disclosure. Power Supply 110 (of FIG. 1) is implemented as a Voltage Regulator Module implemented in the form of a multi-phase switching converter generating two regulated voltages Va (240) and Vb (250).

VRM 110 is shown containing phase controller 210, smart power stages (SPS) SPSA-1 (220-1) through SPSA-6 (220-6), SPSB-1 (230-1) through SPSB-3 (230-3), inductors 225A-1 through 225A-6 and 227B-1 through 227B-3 and capacitors 226A-1 through 226A-6 and 228B-1 through 228B-3. Power supply Va (240) (Rail-A) is generated by a 6-phase buck converter (there are six SPSs-220-1 through 220-6), while power supply Vb (250) (Rail-B) is generated by a 3-phase buck converter (there are three SPSs-230-1 through 230-3). Nodes/Paths 240 and 250 can correspond to paths 112A and 112B of FIG. 1. Also shown in FIG. 2 are the switching nodes 221-1 to 221-6 of the corresponding power stages. In the interest of conciseness, other power supply circuits that generate supplies on paths 113, 114 and 115 are not shown in FIG. 2. The smart power stages will individually or collectively be referred by reference number 220/230, as will be clear from the context. Also, inductors 225A-1 through 225A-3 and 227B-1 through 227B-4 may be collectively or individually referred to by respective numerals 225 and 227, as will also be clear from the context. Similar convention is followed for other blocks/components/signals throughout the disclosure.

In an embodiment of the present disclosure, each of the power stages as well as the phase controller is implemented as separate integrated circuits (ICs). However, in other embodiments, the implementations of the power stages and phase controller may be different.

Phase controller 210 in conjunction with one or more power stages of a rail operates to generate a regulated voltage as output. In the example of FIG. 2, phase controller 210 and one or more of the power stages of Rail-A, namely SPSA-1 through SPSA-6, operate to generate regulated voltage Va (240). Similarly, phase controller 210 and one or more of the power stages of Rail-B, namely SPSB-1 through SPSB-3, operate to generate regulated voltage Vb (250). Accordingly, Va (240) and Vb (250) are shown as being provided as inputs to phase controller 210 to enable operation of one or more feedback loops within phase controller 210 to regulate voltages Va and Vb. Phase controller 210 also receives inductor-current information (regarding current IL, 290, flowing through each of the inductors 225) from each of the SPSs to enable various operations such as current-mode control of voltage regulation, current limiting, short-circuit protection, and balancing the currents generated by each SPS of a same converter (or ‘rail’) so as to make the currents from each SPS of a converter to be substantially equal in magnitude. The other signals flowing between phase controller 210 and the SPSs are described below.

The combination of (corresponding circuitry within) phase controller 210, an SPS and the corresponding inductor and capacitor forms one “phase” of a rail. Thus, for example, SPSA-1, inductor 225A-1, capacitor 226A-1, and the corresponding portion within phase controller 210 form a single buck converter, and one phase of the 6-phase buck converter. It is noted here that, while each phase is shown as having its own separate capacitor (e.g., 226A-1), in another embodiment, only a single larger capacitor (larger capacitance) may be employed at node 240 (as well as 250). In other embodiments, multiple capacitors are placed close to the load powered by the corresponding supply voltage.

Phase controller 210 may be designed to implement automatic phase management (APM). Accordingly, the specific number of power stages (or phases) operated by phase controller 210 can vary depending, for example, on the magnitude of load-current drawn from a rail (e.g., Va 240). In general, the smaller the load-current is, fewer are the number of power stages used/operated and vice-versa.

Each SPS (or in general a ‘power stage’) may be implemented to contain a high-side switch, a low-side switch, gate drive circuitry for the two switches, a temperature monitor circuit and an inductor-current sense circuit/block to provide information indicating the magnitude of inductor-current (290) to phase controller 210. The current supplied by an SPS, and therefore the corresponding inductor-current generally depends on the load current drawn from the supply voltage, although the high-side switch and low-side switch of an SPS may be viewed as ‘driving’ the inductor. Each SPS receives a source of power (which can all be the same source) as an input which is connected to the high-side switch (shown in detail in sections below). In FIG. 2, the supply source is numbered 201, and has a voltage Vin. An example value of Vin in an embodiment of VRM 110 is about 21 volts (V).

Each SPS communicates with phase controller 210 via corresponding signals PWM, SYNC, CS and TEMP. Thus, SPSA-1 is shown connected to phase controller 210 through signal/paths PWMA-1 (211), SYNC-A (212), CSA-1 (213) and TEMPA (214). SPSA-6 communicates with phase controller 210 via signals PWMA-6, SYNC-A, CSA-6 and TEMP (214), although in FIG. 2, the respective connections of signals PWMA-6, SYNC-A and CSA-6 to phase controller 210 are not shown. Similarly, SPSB-1 is shown connected to phase controller 210 through signal/paths PWMB-1 (216), SYNC-B (217), CSB-1 (218) and TEMPB (219). SPSB-3 communicates with phase controller 210 via signals PWMB-3, SYNC-B, CSB-3 and TEMPB (219), although in FIG. 2, the respective connections of signals PWMB-3, SYNC-A and CSB-3 to phase controller 210 are not shown. The other SPSs would have similar connections with phase controller 210.

Signal PWM is an input to an SPS from phase controller 210, and may be viewed as a ‘phase control signal’ that controls the operation (ON and OFF states) of the power switches in the SPS of the corresponding phase. In an embodiment of the present disclosure, signal PWM is a pulse-width modulated (PWM) signal. Accordingly, in such an embodiment, signal PWM is a fixed-frequency, variable duty cycle signal. The duty cycle of the PWM signal is set by phase controller 210 and is designed to generate the desired power supply voltage and/or control/change the current supplied by that phase. For example, PWMA-1 (211) would have a duty cycle as required for the magnitude of Va (240) and the current to be provided by SPSA-1 (220-1). However, in general, signal PWM may have other characteristics depending on the specific implementation details of power supply 110.

For example, in another embodiment, phase controller 210 may employ a constant-ON-time control technique to generate Va. Accordingly, in such an embodiment, signal PWM is a variable frequency, fixed pulse-width (constant-ON-time) signal (i.e., pulse-frequency modulated signal, although the acronym PWM is still used herein to refer to such a signal for case of reference). The frequency of the signal is generally proportional to the desired regulated voltage (Va) and the load current. In yet another embodiment, signal PWM can change between a constant-ON time variable-frequency signal and a fixed-frequency pulse-width modulated signal, based on load current requirements, desired efficiency of power supply 110 and other considerations, as would be apparent to one skilled in the relevant arts.

A PWM signal may be generated to have a logic HIGH state, a logic LOW state or a high-impedance (Hi-Z) state. Typically, the logic HIGH and logic LOW states of the PWM signal correspond respectively to the voltages (within error/noise margins) of the positive and negative rails of the power supply of the circuit generating the PWM signal, and the Hi-Z state corresponds to the mid-rail voltage of the power supply (or a voltage-window around the mid-rail voltage), as is well known in the relevant arts. However, other conventions can be employed for the three states of the PWM signal as would be apparent to one skilled in the relevant arts. Typically, the PWM signal needs to remain within the voltage-window noted above for a predetermined minimum duration for a power stage to correctly identify a Hi-Z state.

Signal PWM controls the opening and closing of the high-side switch and the low-side switch of a phase/power stage via the logic HIGH and logic LOW states. In an embodiment, a logic high level of PWMA-1 causes the high-side switch and the low-side switch in SPSA-1 to be respectively closed and open. A logic low level of PWMA-I causes the high-side switch and the low-side switch in SPSA-1 to be respectively open and closed. Intervals in which Hs switch is ON may be viewed as a ‘first phase’ (or ‘high-side phase’), and intervals in which LS switch is ON may be viewed as a ‘second phase’ (or ‘low-side phase’). The first and second phases repeat, and are thus periodic. The high-side switch and the low-side switch may be viewed as respectively ‘driving’ the inductor in each of the first phases and second phases periodically. It is noted that the terms ‘first phase’ and ‘second phase’ are not to be confused with the phases of a multi-phase converter (as noted above).

The Hi-Z state of the PWM signal indicates to the power stage that the power stage is not to operate in generating the output voltage, i.e., be ‘inactive’. Thus, when PWM is in the Hi-Z state, both the high-side and low-side switches of the stage are OFF, and the power stage can go to low-power/power-down modes. In general, phase controller 210 is designed to generate the PWM signal in a manner capable of indicating three states, with one of the three states indicating that the corresponding power stage is to be inactive. It will be apparent to one skilled in the relevant arts that such tri-state capability can be implemented in alternative ways. As an example, phase controller 210 can be implemented to generate PWM as a conventional binary signal with the power stages implemented to identify a Hi-Z state if the PWM signal is turned OFF, i.e., not generated at all.

As is well known in the relevant arts, the PWM signals to each SPS of a same converter may be staggered, i.e., delayed with respect to each other in phase such that typically no two high-side switches of a rail (i.e., in respective SPSs) are ON at the same time. Such a technique is employed for reasons such as, for example, to ensure that the peak instantaneous current drawn from Vin is relatively low at all times.

Signal TEMP is an output (e.g., a voltage) from an SPS to phase controller 210, and provides information regarding the temperature in the SPS. Phase controller 210 may process the TEMP signal (or the information contained in it) to adjust the current supplied by that phase, or for shut-down of the VRM in the event of a fault. The TEMP outputs of each phase of a converter are wired together, and a single input (for e.g., TEMPA 214) is connected to phase controller 210. The maximum of the TEMP outputs of a phase is driven on the wired connection.

Signal SYNC is an input to an SPS and may be used by phase controller 210 for the purposes of waking-up the SPS upon power-up of the power supply 110, and also to indicate the power-mode (e.g., PS2, PS3), i.e., output current requirement, of the multi-phase converter. Typically, all SPSs of the same converter share a single SYNC signal (e.g., SYNC-A 212).

Signal CS (current-sense) is an input to phase controller 210 from an SPS/phase, and contains information regarding the instantaneous magnitude of the inductor-current of that phase. The information can be in the form of a current, voltage, digital values, etc., depending on the specific implementation of the power stages and phase controller 210. A CS block in an SPS implements the current-sense operation and sends signal CS to phase controller 210.

In an embodiment of the present disclosure, the current-sense block of a power stage sends the sensed inductor-current information to phase controller 210 in the form of a current that can be of either the same magnitude as the inductor-current or (more typically) be a scaled-down version (in terms of magnitude) of the inductor-current. Correspondingly, in the embodiment, phase controller 210 is designed to receive the information in the form of a current, with the scaling factor being known to phase controller 210 as well as the (corresponding) power stage when scaling is used.

As noted above, each SPS provides its CS signal (213) to phase controller 210 to enable phase controller 210 to perform various operations such as current-mode control of voltage regulation, current limiting, short-circuit protection, respond to an over-current condition, and balancing the currents generated by each SPS of a buck converter so as to make the currents from each SPS of a converter to be substantially equal in magnitude.

One problem with measuring (or sensing) the inductor-current is when a switch (HS or LS) is ON only for a very short duration. Generally, the duration for which the HS switch and LS switch are ON in the respective phases (the first and second phases noted above) depends on the difference between Vin and Va (or regulated output voltage in general). If Vin is much greater than Va (e.g., Vin equals 21V and Va is 1V), then the first phase (also termed charging phase) is of a very short duration, while the second phase (also termed discharging phase) is of a comparatively long duration.

In general, it may be difficult to measure the inductor-current reasonably accurately during a very short phase (hereinafter referred to as the ‘shorter phase’, such as the first phase noted above). On the other hand, it may be easier to measure the inductor-current fairly accurately during a long phase (hereinafter referred to as the ‘longer phase’, such as the second phase noted above). An example of such very short duration is when the duty cycle of the PWM signal is around 5%, and the period of the PWM signal is 1.6 micro-seconds (us). The duration of the longer phase is greater than or equal to that of the shorter phase. When the durations of the longer and shorter phase are equal, inductor-current may be measured in any one of the phases.

Typically, a blanking duration is introduced between the end of the shorter phase and the immediately following longer phase to allow transients in the CS block to settle. In the blanking duration, the output of the CS block is blanked, i.e., the output of the CS block is disconnected from CS pin (213). The magnitude of sensed-current (CS signal) during the blanking duration may be held at the last measured magnitude (scaled or otherwise) of inductor-current before the start of the blanking duration. At the end of the blanking duration till the end of the longer phase, output of the CS block is un-blanked, i.e., the output of the CS block is connected to CS pin (213). The magnitude of sensed-current (CS signal) during the un-blanked duration is inductor-current magnitude (or a scaled-down version thereof).

In order to measure inductor-current reasonably reliably in the longer phase, the ‘minimum duration that the switch being driven in the longer phase needs to be ON’ (hereinafter T-min-long duration) should be larger than the blanking duration by a ‘certain time interval’ (hereinafter referred to as ‘minimum post-blank duration’). As an example, if the blanking duration is 120 nano-seconds (ns) and minimum post-blank duration is 30 ns, then T-min-long may be at least 150 ns.

If the above condition is not met, inductor-current may not be measured reliably, and accordingly operations dependent on inductor-current measurement (such as current limiting, over-current protection, etc. noted above) may fail, leading to undesirable consequences which are unacceptable at least in some environments.

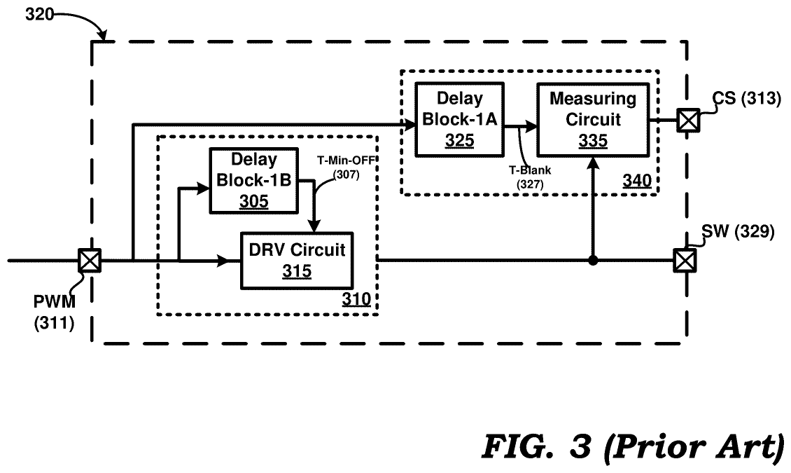

The above condition may not be met in prior implementations of power stage, as briefly described next with respect to an example prior power stage of FIG. 3.

### 4. Prior Power Stage

FIG. 3 is a diagram depicting pertinent implementation details of a prior power stage and the problems associated with that implementation. Prior power stage 320 is shown containing gate driver 310 and current-sense block 340. Gate driver 310 in turn is shown containing delay block-1B 305 and DRV circuit 315. Current-sense block 340 in turn is shown containing delay block-1A 325 and measuring circuit 335. Also shown in FIG. 3 are current-sense pin (313) and switching node (329). Other components inside prior power stage 320 such as high-side switch, low-side switch, etc. are not shown in FIG. 3 in the interest of conciseness.

Gate driver 310 receives signal PWM 311, and in response to the logic level of PWM 311, generates the appropriate voltages (drive signals) on respective paths (not shown in FIG. 3) to turn ON and turn OFF HS switch and LS switch (contained in power stage 320) in corresponding intervals indicated by PWM 311. Delay block-1B (305) generates pulse T-min-OFF (307) with a pulse-width corresponding to duration T-min-long noted above, assuming that the second phase is the longer phase. DRV circuit 315 uses pulse 307 in combination with PWM signal 311 to generate drive signals to turn ON/OFF HS switch and LS switch.

Current-sense block 340 measures/senses the inductor-current, and provides the current-sense information to phase controller on path 313. Delay block-1A (325) generates pulse T-blank (327) internal to current-sense block 335 with a pulse-width corresponding to the blanking duration noted above. Measuring circuit 335 uses pulse 327 to disconnect output of block 335 from CS-pin (313) in the blanking duration.

The magnitude of desired delays to be generated by delay block-1A (325) and delay block-1B (305) may be fixed, having pre-determined values configured in prior power stage 320, with the magnitude of desired delay of delay block-1B (305) being greater than that of delay block-1A (325). Delay blocks 305 and 325 may be implemented using RC delay circuits, delay lines, etc.

Delays generated by delay blocks 305 and 325 can vary due to reasons such as process, voltage and temperature (PVT) variations, aging, device mismatches, etc. Since delays generated by delay blocks 305 and 325 are independent of each other (i.e., the delay generated by one delay block is not dependent on or related to the delay generated by the other delay block in the time domain), such variations in delays generated by either one or both of delay blocks 305 and 325 may result in (T-min-OFF duration minus T-blank duration) not being sufficient to measure inductor-current reliably. Additionally, any offset in the starting times of T-min-OFF and T-blank may also result in the problem noted above.

In order to minimize the variations noted above, prior solutions such as increasing size of devices, adding extra voltage and/or current sources, or using redundant and fault-tolerant circuits, may be employed. However, such prior solutions may result in increased area, power and complexity of IC design.

Embodiments of the present disclosure overcome the problems noted above, as described next.

### 5. Smart Power Stage (SPS)

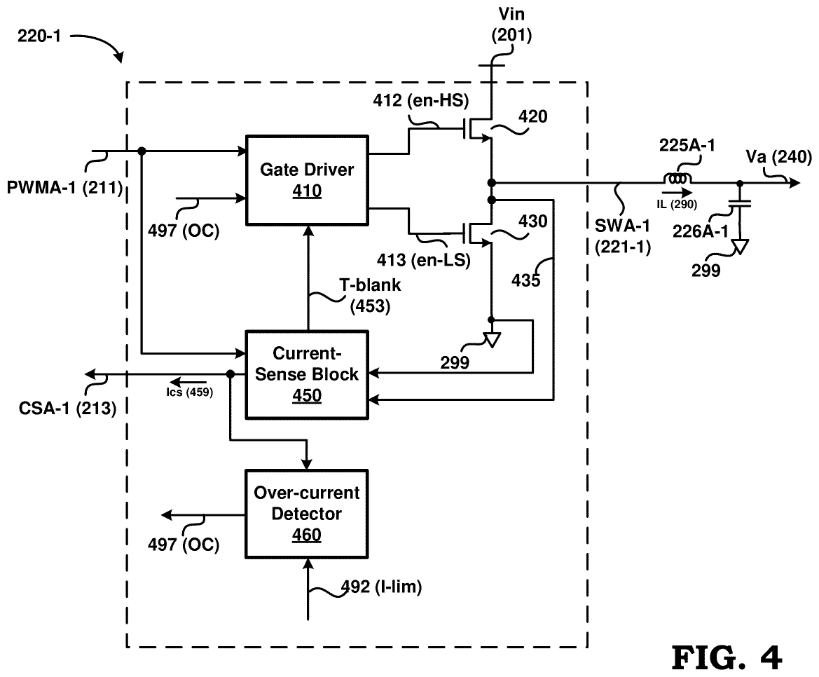

FIG. 4 is a diagram illustrating the implementation of an SPS in an embodiment of the present disclosure. SPSA-1 (220-1) is shown in detail in FIG. 4. The other SPSs can also be implemented to be similar to SPSA-1. SPSA-1 is shown containing gate driver 410, high-side (HS) switch 420, low-side (LS) switch 430, current-sense block 450 and over-current detector 460. Also shown in FIG. 4 are inductor 225A-1 and capacitor 226A-1. Node 240 provides the supply voltage Vout. Current ‘IL” represents the inductor-current through inductor 225A-1, and current “ICS” (459) represents the sensed-current provided as output on CS pin (213).

It is noted herein that only components as relevant to the understanding of the disclosure are depicted in FIG. 4. It is understood that SPS 220-1 can contain more or fewer blocks than those shown in FIG. 4. For example, although not shown in FIG. 4 in the interest of conciseness, power stage 220-1 may contain various other blocks/circuits such as a temperature sensor, level-shifters, etc.

In the illustrative embodiment, it is assumed that the first phase (when HS switch 420 is ON and LS switch 430 is OFF) is the ‘shorter’ phase and the second phase (when HS switch 420 is OFF and LS switch 430 is ON) is the ‘longer phase’ noted above. Aspects of the present disclosure are equally applicable when the first/HS phase is the longer phase and the second/LS phase is the shorter phase with corresponding changes to circuitry inside power stage 220-1, as will be apparent to a skilled practitioner by reading the disclosure herein.

Gate driver 410 operates to generate drive signals en-HS 412 and en-LS 413 based on signal PWMA-1 (211) received from phase controller 210. Gate driver 410 is also shown receiving signals 497 (OC) and T-blank (453), which will be described below in detail.

HS switch 420 and LS switch 430 are each shown implemented as an N-channel MOSFET (Metal Oxide Semiconductor Field Effect Transistor) with gate driver 410 driving the gate terminals of the MOSFETs. Alternative embodiments may implement the switches differently. In the example of FIG. 4, when PWM 211 is a logic HIGH, gate driver 410 generates respective appropriate voltages on paths 412 (en-HS) and 413 (en-LS) to switch-ON MOSFET 420 and switch-OFF MOSFET 430. Signals en-HS (412) and en-LS (413) may thus be considered as ‘drive signals’, driving the respective transistors. When PWM 211 is a logic LOW, gate driver 410 generates respective appropriate voltages on paths 412 and 413 to switch-OFF MOSFET 420 and switch-ON MOSFET 430. When PWM 211 is a Hi-Z state, gate driver 410 generates the respective appropriate voltages on paths 412 and 413 to switch-OFF both of MOSFET 420 and 430.

Gate driver 410 generates en-LS (413) as the inverse of en-HS (412) but with ‘guard’ intervals on either side of en-HS (412) to ensure that the HS and LS switches are never both ON in any interval to prevent short from Vin to ground (shoot-through condition). Gate driver 410 receives logic signal (497) indicating over-current condition. If an over-current condition exists (logic signal 497 is logic HIGH), then gate driver 410 generates respective appropriate voltages on paths 412 and 413 to switch-OFF both MOSFET 420 and MOSFET 430. Additionally, gate driver 410 may communicate to phase controller 210 about the over-current condition on appropriate pin/path.

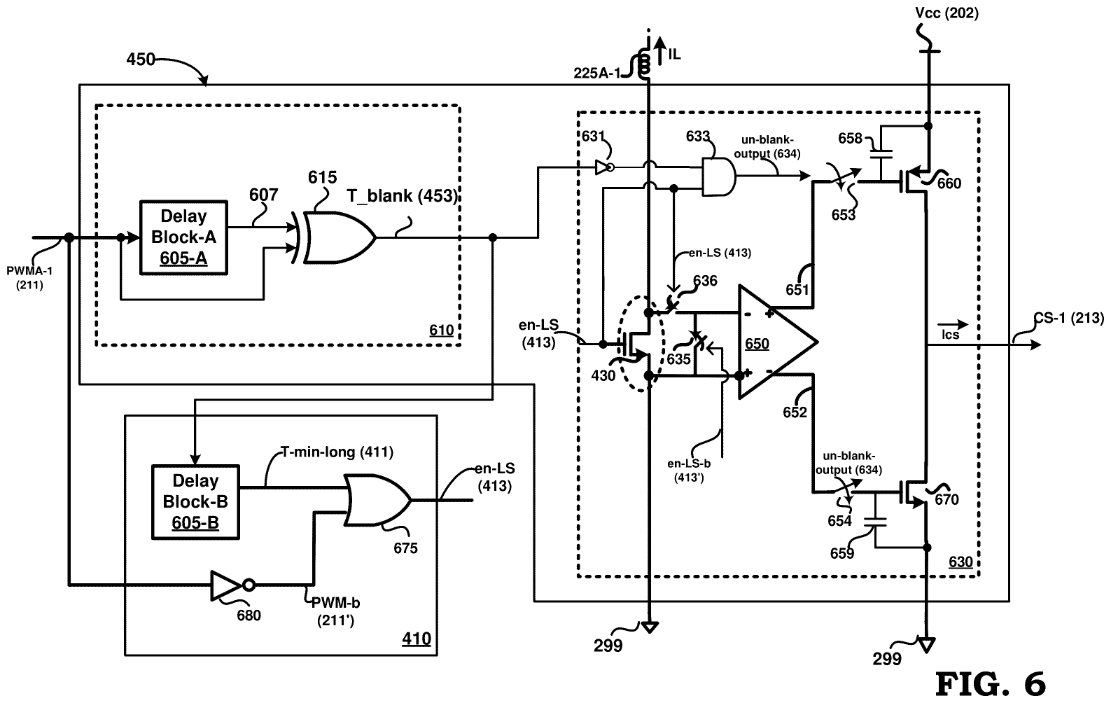

Current-sense block 450 operates to determine the magnitude (for example, instantaneous magnitude) of the inductor-current (IL 290, through inductor 225A-1), with or without scaling, and provides information indicating the inductor-current magnitude as an output on node 213. In an embodiment described below with reference to FIG. 6, current-sense block 450 employs sensing of the voltage-drop across the LS switch 430 for directly obtaining the inductor-current magnitude (or a scaled-down version thereof) when the LS switch is ON, and ‘constructs’ (or emulates) the inductor-current magnitude when the HS switch 420 is ON. Current-sense block 450 generates pulse T-blank on path 453 with a pule-width equaling the blanking duration noted above.

Over-current detector 460 operates to determine if the inductor-current exceeds a maximum allowed or expected magnitude. Over-current detector 460 compares received inductor-current (ICS) information (213) (of the LS phase) and current I-lim 492 (or information/voltage indicative of the current) representing the maximum allowed/expected inductor-current. I-lim 492 may be received from phase controller 210 or may be configured at the time of design within SPSA-1 (220-1) in a known way. Based on Ics (213) and I-lim 492, over-current detector 460 generates logic signal 497 indicating whether an over-current condition exists or not. If an over-current condition exists, over-current detector 460 asserts logic signal 497 to HIGH. Otherwise, over-current detector 460 maintains signal (497) in a de-asserted (LOW) state. Over-current detector 460 may be implemented in a known way.

It is noted herein that over-current detection (and protection) may be performed in both shorter phases and longer phases noted above. For example, if the first phase (HS switch 420 is ON) is the shorter phase, over-current detection may be performed in such phases to account for fault/error conditions (such as when PWMA-1, 211, continues to be in logic high state starting from the beginning of a first phase, thus leading to inductor-current increasing to unacceptably high levels).

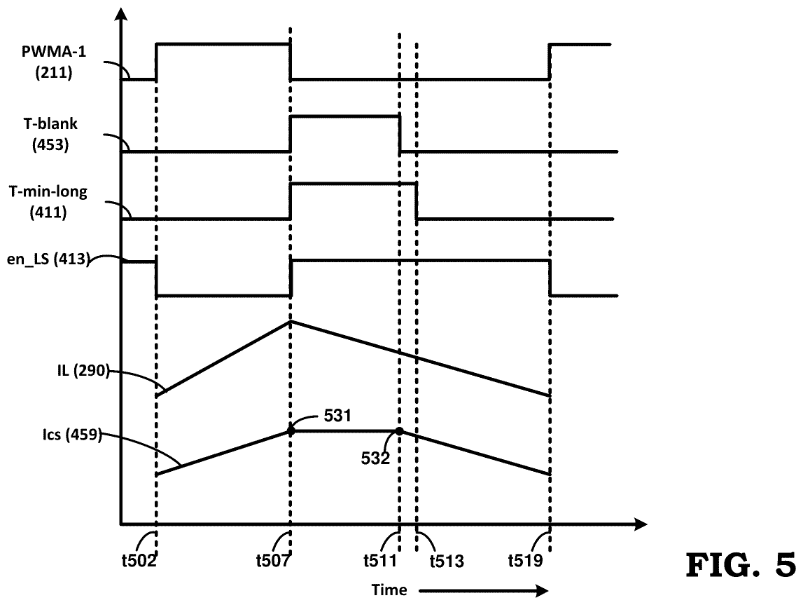

As noted above, T-min-long should be larger than the blanking duration by the minimum post-blank duration. According to an aspect of the present disclosure, the above condition is ensured by generating T-min-long relative to T-blank. Specifically, delay corresponding to the minimum post-blank duration is started after the end of the blanking duration, as will be described next with respect to FIG. 5.

### 6. Generation of T-min-Long Relative to T-blank

FIG. 5 is a timing diagram (not to scale) illustrating the relative timing of T-min-long (411, not shown in FIG. 4) and T-blank (453), in an embodiment of the present disclosure. Waveforms of PWMA-1 (211), T-blank (453), T-min-long (411), en-LS (413), IL (290) and Ics (459) are depicted in FIG. 5.

When PWMA-1 is logic high (time interval t502-t507), HS switch 420 is ON (LS switch 430 is OFF) and current flows from Vin to the load (connected to Va node, but not shown) via HS MOSFET 420 and inductor 225A-1 with rising slope. When PWMA-1 is logic low (time interval t507-t519), LS switch 430 is ON (HS switch 420 is OFF), and the inductor-current flows in the loop formed by LS switch 430, inductor 225A-1 and load with falling slope. One period of PWMA-1 signal may be referred to as a ‘cycle’ of operation of an SPS or switching converter in general.

The starting edge (here, rising edge) of pulse T-blank (453) (at t507) is shown as being generated synchronous with falling edge of PWMA-1 (211) which corresponds to start of the second phase in the illustrative embodiment. It is noted herein that the term ‘synchronous’ used to refer timing relation of one or more signals indicates that ideally the one or more signals (e.g., here, the falling of signal PWM-1 (211) and the starting edge of pulse T-blank, 453) occur at the same time. Practically, there may be some delays (intentional, such as guard intervals, etc., or otherwise, such as propagation delays, etc.) between the occurrence of the one or more signals.

In general, starting edge of pulse T-blank (453) is generated synchronous with start of the longer phase. Thus, when the first phase is the longer phase, starting edge of pulse T-blank is generated synchronous with the rising edge of PWMA-1 (211).

Pulse-width (t507-t511) of T-blank (453) corresponds to the blanking duration noted above. End of T-blank duration (at time instant t511) triggers the start of the minimum post-blank duration (t511-t513). Thus, T-min-long (411) is shown with pulse-width (t507-t513) equaling T-blank duration plus minimum post-blank duration, thereby preventing duration of T-min-long from being less than or equal to that of T-blank. The minimum post-blank duration indicates the duration by which T-min-long (411) should ideally exceed T-blank (453) duration in order to enable reliable measurement of inductor-current in the longer phase.

Signal en-LS (413) is generated as logic low in the first phase (time interval t502-t507). Signal en-LS transitions to logic high synchronous with falling edge of signal PWMA-1 (211), and is maintained at logic high until end of T-min-long duration or end of duration for which PWMA-1 (211) is logic low, whichever is longer. Thus, in FIG. 5, en-LS (413) is shown transitioning to logic low at t519 (i.e., end of duration for which PWMA-1, 211 is logic low).

Point 531 on waveform Ics (459) at t507 represents the (emulated) magnitude of the inductor-current at the end of the first phase and the beginning of the second phase. Waveform Ics (459) retains/holds the previously measured value (531) until the end of blanking duration (at time t511) as depicted by point 532. At the end of blanking duration, t511, waveform Ics (459) represents the actual inductor-current magnitude (or a scaled version thereof).

Due to the provision of generating T-min-long relative to T-blank in a serial fashion (i.e., with the end of T-blank duration triggering the start of the minimum post-blank duration noted above), it may be ensured that duration of T-min-long is greater than that of T-blank. As a result, one or more of the drawbacks (e.g., as noted above) of at least the prior power stage noted with respect to FIG. 3 are overcome. SPS 220-1 may therefore reliably measure inductor-current in the longer phases.

The implementation details of gate driver 410 and current-sense block 450 in an embodiment of the present disclosure are provided next.

### 7. Current-Sense Block and Gate Driver

FIG. 6 is a diagram illustrating the implementation details of a gate driver and a current-sense block in an embodiment of the present disclosure. Current-sense block 450 is shown containing circuits 610 and 630. Gate driver 410 is shown containing delay block-B (605-B), inverter 680 and OR gate 675. It is noted herein that the details of circuits 610, 630 and gate driver 410 as relevant to the disclosure have been provided and described. However, it is to be understood that alternative implementations of gate driver 410 and current-sense block 450 may use more or fewer components and circuitry. Label 299 represents a ground connection.

Circuit 610 generates pulse T-blank (453) from signal PWMA-1 received on path 211, starting synchronous with start of the longer phase (the second phase in the illustrative embodiment).

Circuit 630 measures (or senses) the inductor current IL (inductor 225A-1 of FIG. 2 is also shown for clarity) in the second phases (i.e., when LS switch 430 (FIG. 4) is closed and driving the inductor-current, HS switch 420 being open in the second phases). Circuit 630 re-creates (i.e., creates a replica of) the inductor current in the second phases. As may be observed from FIG. 5, the inductor-current in the second phases has a falling (negative slope). Current-sense block 450 provides the replica inductor current in the second phases at/on node/path CSA-1 (213), as will be described below.

The series connection of transistors 660 and 670 across supply node 202 (Vcc) and ground 299 is referred to herein as “output block”. Transistor 660 is shown as P-channel metal oxide semiconductor field effect transistors (PMOS), and transistor 670 is shown as N-channel metal oxide semiconductor field effect transistors (NMOS). Supply Vcc may be provided to SPSA-1 (as well as the other SPSes) by phase controller 210, or be generated in VRM 110 in a known way.

Circuit 610 is shown containing delay block-A 605-A and XOR gate 615. Delay block-A 605-A generates signal PMW-delayed (607) from input signal PWMA-1 received on path 211. In the illustrative embodiment, delay block-A 605-A operates to delay only the falling edges of PWMA-1 (211) by magnitude of the blanking duration noted above. Thus, the rising edges of PWMA-1 (211) and PWM-delayed (607) are synchronous with each other, while the falling edges of PWM-delayed (607) are delayed by the blanking duration with respect to corresponding falling edges of PWMA-1 (211).

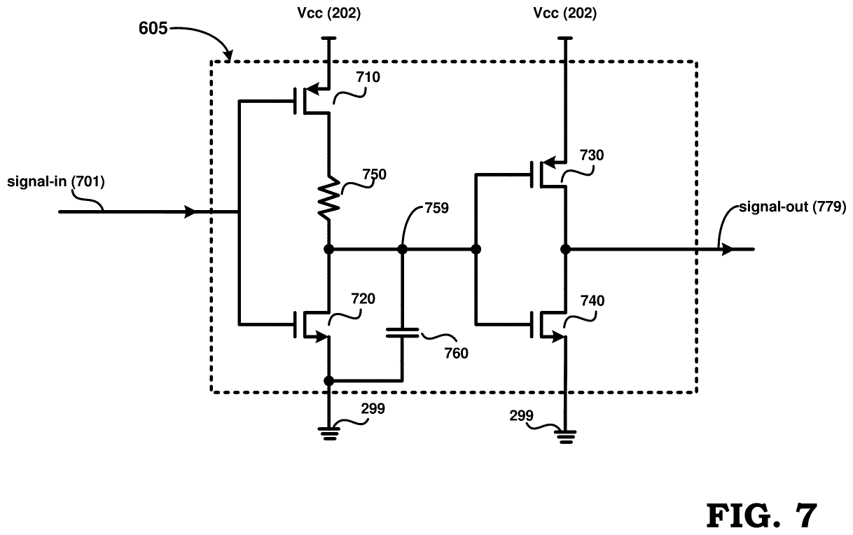

In an embodiment, delay block-A 605-A is implemented using RC delay circuit as described below with respect to FIG. 7. The magnitude of duration of T-blank (453) may be fixed and may be configured at design time in power supply 110 or be received as an input from an external device (not shown) or as a user input (via corresponding means not shown). In the illustrative embodiment, the magnitude of duration of T-blank (453) equals 120 ns.

Signals PWM-delayed (607) and PWMA-1 (211) are provided as inputs to XOR gate 615 in order to generate pulse T-blank (453).

Although the illustrative embodiment depicts a particular logic operation (XOR) using signals PWM-delayed (607) and PWMA-1 (211) in order to generate T-blank (453), aspects of the present disclosure are equally applicable when alternative logic operations (with corresponding signals) are employed to generate T-blank (453), as will be apparent to a skilled practitioner by reading the disclosure herein.

Circuit 630 of current-sense block 450 is shown containing amplifier 650, transistors 660 and 670, capacitors 658 and 659, switches 635, 636, 653 and 654, inverter 631, and AND gate 633. For clarity, LS switch 430 is also shown, although it would typically not be part of circuit 630.

Amplifier 650 receives the voltage across LS switch 430 in the second phases, and provides an amplified output voltage as an output. Amplifier 650 is shown as a fully differential amplifier merely as an example. Other amplifier types and topologies can also be used instead. In an embodiment, amplifier 650 is a fully differential amplifier with gain determined by a feedback network (not shown, but for examples using two pairs of resistors as is well known in the arts) that would be used to operate amplifier 650 in closed-loop mode. In the embodiment, fully differential amplifier receives the voltage across LS switch 430 across the (−) input terminal connected to path 435 and the (+) input terminal connected to ground 299. Fully differential amplifier 650 provides a corresponding amplified difference as output voltage across terminals 651 (+) and 652 (−).

Switches 635 and 636 are respectively controlled by en-LS-b (413′) and en-LS (413). Control signal en-LS-b (413′) is the logical inverse of en-LA (413). Switch 635 is closed when LS switch 430 is OFF and HS switch 420 is ON. Switch 635 is open when LS switch is ON. On the other hand, switch 636 is closed when LS switch is ON and open when LS switch is OFF.

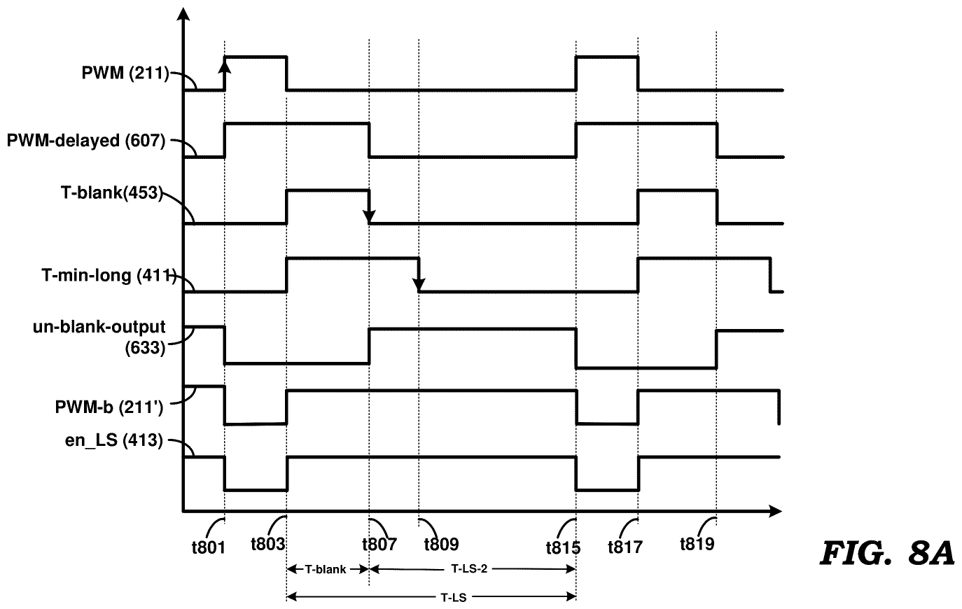

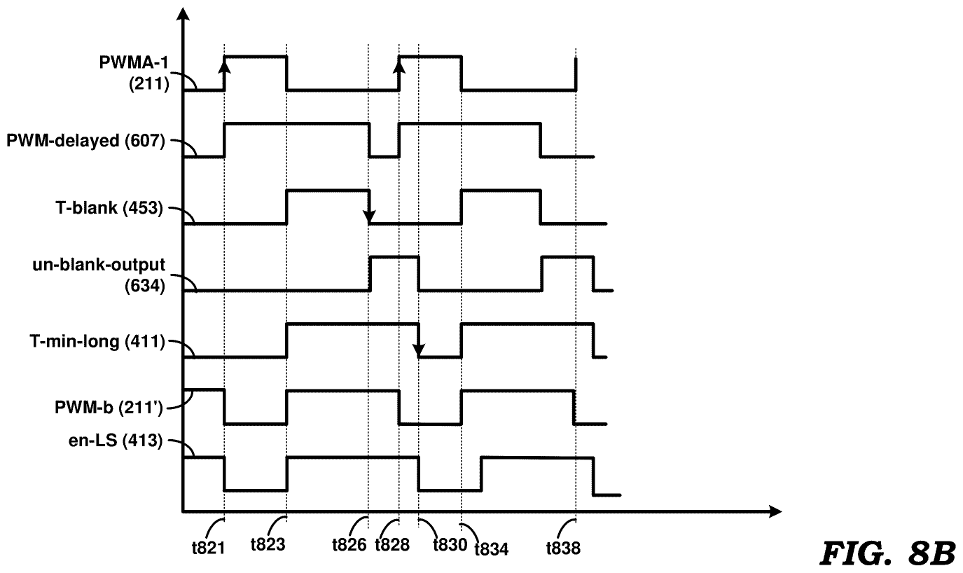

Control signal un-blank-output (634) causes each of switches 653 and 654 to be closed at the end of the blanking duration, and to be opened at the end of the corresponding second phase, the switches remaining closed for the duration from the end of the blanking phase to the end of the corresponding second phase (time interval T-LS-2 in FIG. 8A).

Though not shown in FIG. 6, control signal un-blank-output (634) may also be used by a comparator (not shown) inside over-current detector 480 to enable over-current detection only for the duration from the end of the blanking duration to the end of the corresponding second phase (time interval T-LS-2 in FIG. 8A).

LS switch 430 is switched ON (and is therefore conductive) by signal ‘en-LS’ (413 of FIG. 4) in (and for the duration of) the second phase only. Thus, the current (IL) through inductor 225A-1 is sensed by circuit 630 by measuring/obtaining the voltage across the LS switch 430 in the second phase. For example, if the LS switch has a 2.5 milli Ohm resistance Ron and is sourcing an inductor current of 40A, then the voltage across LS switch 430 will be 100 mV. Sensing the voltage across the LS switch 430 is a lossless method of sensing the current. However, other techniques for obtaining a measure of the magnitude of inductor current in the second phases can also be used, as would be apparent to one skilled in the arts upon reading this disclosure.

Delay block-B 605-B (of gate driver 410) generates pulse T-min-long on path 411 from input pulse T-blank received on path 453 with pulse-width equaling a sum of duration of T-blank (453) and the minimum post-blank duration noted above. In other words, the end of T-blank duration triggers the start of the minimum post-blank duration such that the duration of T-min-long exceeds that of T-blank by the minimum post-blank duration.

In the illustrative embodiment, delay block-B 605-B operates to delay only the ending edges of pulse T-blank (453) by magnitude of minimum sampling noted above. Thus, the starting edges (e.g., rising edges) of pulses T-blank (453) and T-min-long (411) are synchronous with each other, while the ending edges (e.g., falling edges) of T-min-long (411) are delayed by the minimum post-blank duration with respect to corresponding ending edges of T-blank (453).

In an embodiment, delay block-B 605-A is implemented using RC delay circuit as described below with respect to FIG. 7. The magnitude of the minimum post-blank duration may be determined at design based on simulation results, taking into account process corners, operating voltage and ambient temperature, and may be configured in power stage 220 or be received as an input from an external device (not shown) or as a user input (via corresponding means not shown). In the illustrative embodiment, the magnitude of the minimum post-blank duration equals 30 ns. Thus, duration of pulse T-min-long equals 120 ns plus 30 ns, i.e., 150 ns.

Signals T-min-long (411) and PWM-b (211′) (representing logical inverse of PWMA-1, 211) are provided as inputs to OR gate 675 in order to generate signal en-LS (413).

Although the illustrative embodiment depicts circuitry for generation of pulse T-blank (453) as being inside current-sense block 450, and circuitry for generation of pulse T-min-long (411) as being inside gate driver 410, in alternative embodiments, logic block/circuit to generate one or both of pulses T-blank (453) and T-min-long (411) may be implemented outside current-sense block 450 and/or gate driver 410, as will be apparent to a skilled practitioner by reading the disclosure herein.

The combined operations of circuits 610 and 630, and gate driver 410 in the first and second phase is now described with combined reference to FIG. 6 and FIG. 8A.

### 8. Example Operation of SPS

FIG. 8A is a timing diagram (not to scale) illustrating example waveforms generated at various nodes of SPS 220 in an embodiment of the present disclosure. Example waveforms of PWMA-1 (211), PWM-delayed (607), T-blank (453), T-min-long (411), PWM-b (211′) and en-LS (413) are depicted in FIG. 8A.

### (A) First Phase:

In operation, LS switch 430 is switched OFF by drive signal en-LS (413) at the start of the first phase (e.g., time instants t801, t815 in FIG. 8A). LS switch 430 is switched ON at the start of the immediately next second phase (e.g., t803, t817 of FIG. 8A). When LS switch 430 is OFF, switch 635 is closed (and switch 636 is open), and accordingly inputs to amplifier 650 are both shorted with each other and connected to ground 299. Alternatively, inputs of amplifier 650 may both be connected to a same reference potential. Thus, voltage at SW node is not sampled in the first phases. Switches 653 and 654 are open for the duration of the first phase. An emulation circuit (not shown in FIG. 6) estimates the inductor-current in the first phase without sensing or measuring the inductor-current in the first phases, and provides the emulated current on path CS (213).

### (B) Second Phase:

LS switch 430 is switched ON by drive signal en-LS (413) at the start of the second phase (e.g., time instants t803, t817 in FIG. 8A). At the start of and for the entire duration of second phases, when LS switch 430 is ON (time interval t803-t815 in FIG. 8A), switch 635 is open and switch 636 is closed. Thus, the voltage across the LS switch 430 is provided to amplifier 650 at the start of second phases. However, output on CSA-1 is disabled for the duration of T-blank (453) to prevent unsettled/transient output from being provided on it. Switches 653 and 654 are closed at the end of the blanking duration, and remain closed for the duration from the end of the blanking duration to the end of the corresponding second phase (time interval T-LS-2 in FIG. 8A).

As noted above, blanking duration is an interval in which amplifier 650 is ON (starting from, the start of T-blank), but whose outputs are not yet settled and correctly reflecting the input. This occurs due to the bandwidth (BW) of differential amplifier 650 being finite. Therefore, amplifier 650 may need some time from being switched ON (e.g., at the start of T-LS) till it reaches steady-state operation and generates outputs correctly. The blanking duration may be set by a designer/user based on the BW of differential amplifier 650.

In the second phase, voltage 651 and 652 respectively cause transistors 660 and 670 to source and sink respective currents based on the specific magnitudes of voltages 651 and 652 and therefore the input voltage to the amplifier. Thus, the output block effectively operates as a voltage to current converter. As a result, a difference current (denoted by Ics) between the current sourced by transistor 660 and the current sunk by transistor 670 is provided on path 213 (CSA-1). The difference current is a replica (scaled or actual) of the inductor current in the second phase (or more specifically for the portion corresponding to end of blanking interval to the end of the second phase).

Additionally, capacitors 658 and 659 would charge/discharge depending on voltages on path 651 and 652 respectively, and at the end of the second phase (e.g., t815 in FIG. 8A) would each have a voltage across them representative of (or corresponding to) the difference current on path 213 at the end of the second phase. In other words, capacitors 658 and 659 enable to store (or hold) the ‘information’ (in this two voltages) representative of the inductor current at the end of the second phase (e.g., t815). Such ‘valley hold’ capability of circuit 630 is required since the immediately following first phase, an emulation circuit (not shown in FIG. 6) that estimates the inductor current in the first phase requires this initial condition. For example, the emulation circuit of current-sense block 450 operates to create a replica of inductor current in the first phases without sensing or measuring the inductor current in the first phases. Emulation circuit may be implemented, for example, as described in US Publication No: US20240030811A1.

In the second phases, gate driver 410 generates pulse T-min-long (411) by delaying the falling edges of corresponding pulse T-blank (453) by the minimum post-blank duration (time interval t807-t809 in FIG. 8A). Gate driver 410 generates logic high on drive signal en-LS (413) at the start of the second phase (t803, t817 in FIG. 8A), and maintains en-LS (413) at logic high for the duration of T-min-long (411) or for the duration when PWMA-1 (211) is a logic low (t803-t815 in FIG. 8A), whichever is longer. Thus, in FIG. 8A, en-LS (413) is shown to be at logic high in the duration t803-t815 since PWMA-1 (211) is at logic low for a duration longer than T-min-long (411).

Even if signal PWMA-1 (211) transitions to logic high before the end of duration T-min-long (411), gate driver 410 maintains en-LS (413) at logic high at least for duration of T-min-long (411) as illustrated in FIG. 8B.

FIG. 8B is a timing diagram (not to scale) illustrating the manner in which a low-side switch is kept ON for the minimum OFF-time, in an embodiment of the present disclosure. Time intervals t821-t823 and t828-t834 depict the first phases and time intervals t823-t828 and t834-t838 depict the second phases.

In the second phase t823-t828, time interval t823-t826 is the blanking duration and t823-t830 in the minimum time that LS switch should be ON (T-min-long, 411).

However, at t828, PWMA-1 (211) is shown is shown transitioning to logic high before end of duration T-min-long (411). By operation of OR gate 675 inside gate driver 410, en-LS (413) is maintained at logic high till end of duration T-min-long (411), i.e., till t830.

The implementation details of delay blocks 605-A and 605-B in an embodiment of the present disclosure are provided next.

### 9. Delay Block

FIG. 7 is a diagram illustrating the implementation details of delay block 605 in an embodiment of the present disclosure. In an embodiment, delay block 605 corresponds to both of delay blocks 605-A and 605-B depicted in FIG. 6. Delay block 605 is shown containing asymmetric inverter (containing transistors 710, 720, resistor 750 and capacitor 760) and symmetric inverter (containing transistors 730 and 740). Signal-in (701) represents the input signal whose falling edges only are delayed by delay block 605 to generate signal signal-out (779). Thus, when delay block 605 is implemented as delay block 605-A, signal-in (701) would correspond to signal PWMA-1 (211) and signal-out (779) would correspond to signal PWM-delayed (607).

The RC time-constant of the RC circuit constituted of resistor R (750) and capacitor (760) determines the slope of rising edge of signal-in at node 759. The switching voltage of symmetric inverter is fixed and may designed to ebe mid-way between Vcc (202) and ground 299. Thus, the RC circuit generates an exponential ramp, while the threshold comparison of comparator defines a decision threshold and produces an output edge (of signal-out, 759) when crossing the threshold.

The values of R (750) and C (760) are chosen such that delay block 605 provides the desired delay. Thus, in the illustrative embodiment, R and C values for delay block-A (605-A) are designed to provide delay of 120 ns (duration of T-blank, 453), and R and C values for delay block-B (605-B) are designed to provide delay of 30 ns (minimum post-blank duration noted above).

Although the illustrative embodiment depicts RC delay circuit to realize the desired delays, aspects of the present disclosure are equally applicable when alternative delay-generating circuits/components (such as counters, delay lines, timers, etc.) are employed, as will be apparent to a skilled practitioner by reading the disclosure herein.

One benefit of the solution is that since minimum post-blank duration starts after end of the blanking duration, T-min-long being less than or equal to the blanking duration is prevented even taking into account any variations in delays generated by blocks 605-A and 605-B. The constraint of both delays having to start at the same time is no longer present according to aspects of the present disclosure. Accordingly, the solution further reduces the possibility of the condition not being met, as contrasted with the prior art described above.

In this manner, aspects of the present disclosure enable measurement of inductor-current in a power stage of a switching converter.

### 10. Conclusion

References throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

While in the illustrations of FIGS. 1, 2, 4, 6 and 7, although terminals/nodes are shown with direct connections to (i.e., “connected to”) various other terminals, it should be appreciated that additional components (as suited for the specific environment) may also be present in the path, and accordingly the connections may be viewed as being “electrically coupled” to the same connected terminals.

It should be appreciated that the specific type of transistors (such as NMOS, PMOS, etc.) noted above are merely by way of illustration. However, alternative embodiments using different configurations and transistors will be apparent to one skilled in the relevant arts by reading the disclosure provided herein. For example, the NMOS transistors may be replaced with PMOS (P-type MOS) transistors, while also interchanging the connections to power and ground terminals.

Accordingly, in the instant application, the power and ground terminals are referred to as constant reference potentials, the source (emitter) and drain (collector) terminals of transistors (though which a current path is provided when turned on and an open path is provided when turned off) are termed as current terminals, and the gate (base) terminal is termed as a control terminal.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A power stage of a switching converter comprising:
a high-side switch and a low-side switch respectively operated by a first drive signal and a second drive signal, said first drive signal and said second drive signal to be respectively ON to drive respective currents through an inductor in a high-side phase and a low-side phase;
a gate driver to generate said first drive signal and said second drive signal based on a control signal received from a phase controller, wherein said control signal is received with a first logic level in a first interval and with a second logic level in a second interval; and
a current-sense block to generate a sensed-current signal representing an instantaneous magnitude of inductor-current flowing through said inductor, wherein said sensed-current signal is blanked for a first duration upon start of a longer phase of said high-side phase and said low-side phase, with the other one of said high-side phase and said low-side phase being a shorter phase, wherein said sensed-current signal is un-blanked upon end of said first duration, wherein a duration of said longer phase is greater than or equal to a duration of said shorter phase,
wherein said current-sense block generates a first pulse starting synchronous with said start of said longer phase and with pulse-width equaling said first duration,
wherein said gate driver receives said first pulse and generates a delayed pulse starting synchronous with said start of said longer phase and with pulse-width equaling a sum of said first duration and a second duration,
wherein said gate driver generates drive signal for the switch being driven with said longer phase, said drive signal being with said first logic level for a duration of at least said pulse-width of said delayed pulse.

2. The power stage of claim 1, wherein said low-side is said longer phase,
wherein said sum represents a desired minimum duration for which said low-side switch is to be ON in said low-side phase.

3. The power stage of claim 1, wherein said current-sense block comprises:
a first delay block to receive said control signal and to generate a delayed control signal by delaying high-to-low transitions of said control signal by said first duration;
an XOR gate to receive said control signal and said delayed control signal, and to generate said first pulse; and
a current-measuring block to measure said instantaneous magnitude of inductor-current flowing through said inductor in said low-side phases and to emulate said inductor-current in said high-side phases.

4. The power stage of claim 3, wherein said gate driver comprises:
a second delay block to receive said first pulse and to delay ending edges of said first pulse by said second duration to generate ending edges of said delayed pulse; and
an OR gate to receive said delayed pulse and a complement of said control signal, and to generate said drive signal for said low-side switch.

5. The power stage of claim 3, wherein said current-sense block comprises:
an amplifier to amplify a voltage across the switch being driven in said longer phase and to provide an amplified voltage across a pair of terminals;
a first capacitor and a second capacitor;
a first switch coupled to a first terminal in said pair of terminals, and operable to be closed for a duration corresponding to the interval from the end of a blanking phase of said low-side phase to the end of said low-side phase to charge said first capacitor;
a second switch coupled to a second terminal in said pair of terminals, and operable to be also closed for a duration corresponding to the interval from the end of said blanking phase of said low-side phase to the end of said low-side phase to charge said second capacitor;
a first inverter to receive said first pulse and to generate a first-inverted signal; and
an AND gate to receive said second gate drive signal and said first-inverted signal and to generate an un-blank-output signal,
wherein said un-blank-output signal is operable to control the opening and closing of said first switch and said second switch such that said sensed-signal is blanked for said first duration and un-blanked upon end of said first duration.

6. The power stage of claim 5, wherein said current-sense block comprises:
a first transistor and a second transistor coupled in series between a first constant reference potential and a second constant reference potential, wherein said sensed-current signal is provided at a current sense output terminal located at the junction of said first transistor and said second transistor,
wherein a first current terminal of said first transistor is coupled to said first constant reference potential, wherein a second current terminal of said first transistor is coupled to said current sense output terminal, wherein a control terminal of said first transistor is coupled to a corresponding terminal of said first switch,
wherein a first current terminal of said second transistor is coupled to said second constant reference potential, wherein a second current terminal of said second transistor is coupled to said current sense output terminal, wherein a control terminal of said second transistor is coupled to a corresponding terminal of said second switch,
wherein said first capacitor is coupled between said first constant reference potential and said control terminal of said first transistor, and
wherein said second capacitor is coupled between said second constant reference potential and said control terminal of said second transistor.

7. The power stage of claim 6, wherein each of said first delay block and said second delay block is operable to receive a corresponding input-signal and to generate a respective delayed-signal, said delay block comprising:
an asymmetric inverter comprising a third transistor, a fourth transistor, a first resistor and a third capacitor; and
a symmetric inverter comprising a fifth transistor and a sixth transistor, wherein said fifth transistor and said sixth transistor are coupled in series between said first constant reference potential and said second constant reference potential, wherein said delayed-signal is provided at a delay-block-output terminal located at the junction of said fifth transistor and said sixth transistor,
wherein a first current terminal of said third transistor is coupled to said first constant reference potential, a control terminal of said third transistor is coupled to said input-signal of said delay block,
wherein a first current terminal of said fourth transistor is coupled to said second constant reference potential, a control terminal of said fourth transistor is coupled to said input-signal of said delay block,
wherein said first resistor is coupled between a second current terminal of said third transistor and a second current terminal of said fourth transistor,
wherein said third capacitor is coupled between said first current terminal of said fourth transistor and the junction of said resistor and said second current terminal of said fourth transistor,
wherein control terminals of said fifth transistor and said sixth transistor are coupled to said junction of said resistor and said second current terminal of said fourth transistor.

8. A voltage regulator module (VRM) comprising:
a phase controller to generate a regulated supply voltage on a first supply node based on an input voltage received at an input node; and
a smart power stage (SPS) comprising:
a high-side switch and a low-side switch respectively operated by a first drive signal and a second drive signal, said first drive signal and said second drive signal to be respectively ON to drive respective currents through an inductor in a high-side phase and a low-side phase;
a gate driver to generate said first drive signal and said second drive signal based on a control signal received from said phase controller, wherein said control signal is received with a first logic level in a first interval and with a second logic level in a second interval; and
a current-sense block to generate a sensed-current signal representing an instantaneous magnitude of inductor-current flowing through said inductor, wherein said sensed-current signal is blanked for a first duration upon start of a longer phase of said high-side phase and said low-side phase, with the other one of said high-side phase and said low-side phase being a shorter phase, wherein said sensed-current signal is un-blanked upon end of said first duration, wherein a duration of said longer phase is greater than or equal to a duration of said shorter phase,
wherein said current-sense block generates a first pulse starting synchronous with said start of said longer phase and with pulse-width equaling said first duration,
wherein said gate driver receives said first pulse and generates a delayed pulse starting synchronous with said start of said longer phase and with pulse-width equaling a sum of said first duration and a second duration,
wherein said gate driver generates drive signal for the switch being driven with said longer phase, said drive signal being with said first logic level for a duration of at least said pulse-width of said delayed pulse.

9. The VRM of claim 8, wherein said low-side is said longer phase,
wherein said sum represents a desired minimum duration for which said low-side switch is to be ON in said low-side phase.

10. The VRM of claim 8, wherein said current-sense block comprises:
a first delay block to receive said control signal and to generate a delayed control signal by delaying high-to-low transitions of said control signal by said first duration;
an XOR gate to receive said control signal and said delayed control signal, and to generate said first pulse; and
a current-measuring block to measure said instantaneous magnitude of inductor-current flowing through said inductor in said low-side phases and to emulate said inductor-current in said high-side phases.

11. The VRM of claim 10, wherein said gate driver comprises:
a second delay block to receive said first pulse and to delay ending edges of said first pulse by said second duration to generate ending edges of said delayed pulse; and
an OR gate to receive said delayed pulse and a complement of said control signal, and to generate said drive signal for said low-side switch.

12. The VRM of claim 10, wherein said current-sense block comprises:
an amplifier to amplify a voltage across the switch being driven in said longer phase and to provide an amplified voltage across a pair of terminals;
a first capacitor and a second capacitor;
a first switch coupled to a first terminal in said pair of terminals, and operable to be closed for a duration corresponding to the interval from the end of a blanking phase of said low-side phase to the end of said low-side phase to charge said first capacitor;
a second switch coupled to a second terminal in said pair of terminals, and operable to be also closed for a duration corresponding to the interval from the end of said blanking phase of said low-side phase to the end of said low-side phase to charge said second capacitor;
a first inverter to receive said first pulse and to generate a first-inverted signal; and
an AND gate to receive said second gate drive signal and said first-inverted signal and to generate an un-blank-output signal,
wherein said un-blank-output signal is operable to control the opening and closing of said first switch and said second switch such that said sensed-signal is blanked for said first duration and un-blanked upon end of said first duration.

13. The VRM of claim 12, wherein said current-sense block comprises:
a first transistor and a second transistor coupled in series between a first constant reference potential and a second constant reference potential, wherein said sensed-current signal is provided at a current sense output terminal located at the junction of said first transistor and said second transistor,
wherein a first current terminal of said first transistor is coupled to said first constant reference potential, wherein a second current terminal of said first transistor is coupled to said current sense output terminal, wherein a control terminal of said first transistor is coupled to a corresponding terminal of said first switch,
wherein a first current terminal of said second transistor is coupled to said second constant reference potential, wherein a second current terminal of said second transistor is coupled to said current sense output terminal, wherein a control terminal of said second transistor is coupled to a corresponding terminal of said second switch,
wherein said first capacitor is coupled between said first constant reference potential and said control terminal of said first transistor, and
wherein said second capacitor is coupled between said second constant reference potential and said control terminal of said second transistor.

14. The power stage of claim 13, wherein each of said first delay block and said second delay block is operable to receive a corresponding input-signal and to generate a respective delayed-signal, said delay block comprising:
an asymmetric inverter comprising a third transistor, a fourth transistor, a first resistor and a third capacitor; and
a symmetric inverter comprising a fifth transistor and a sixth transistor, wherein said fifth transistor and said sixth transistor are coupled in series between said first constant reference potential and said second constant reference potential, wherein said delayed-signal is provided at a delay-block-output terminal located at the junction of said fifth transistor and said sixth transistor,
wherein a first current terminal of said third transistor is coupled to said first constant reference potential, a control terminal of said third transistor is coupled to said input-signal of said delay block,
wherein a first current terminal of said fourth transistor is coupled to said second constant reference potential, a control terminal of said fourth transistor is coupled to said input-signal of said delay block,
wherein said first resistor is coupled between a second current terminal of said third transistor and a second current terminal of said fourth transistor,
wherein said third capacitor is coupled between said first current terminal of said fourth transistor and the junction of said resistor and said second current terminal of said fourth transistor,
wherein control terminals of said fifth transistor and said sixth transistor are coupled to said junction of said resistor and said second current terminal of said fourth transistor.
